(19) United States
(12) Patent Application Publication
(10) Pub. No.: US 2015/0163564 A1
(43) Pub. Date: Jun. 11, 2015

(54) CONTENT DISTRIBUTION/CONSUMPTION WITH TERTIARY CONTENT

(71) Applicants: Aimee-Michelle Degolyer, Los Gatos, CA (US); Elizabeth Harrington, Menlo Park, CA (US); Marcelino Ford-Livene, Pasadena, CA (US)

(72) Inventors: Aimee-Michelle Degolyer, Los Gatos, CA (US); Elizabeth Harrington, Menlo Park, CA (US); Marcelino Ford-Livene, Pasadena, CA (US)

(21) Appl. No.: 14/102,247

(22) Filed: Dec. 10, 2013

(51) Int. Cl. H04N 21/81; H04N 21/472; H04N 21/44; H04N 21/6587; H04N 21/234; H04N 21/426

(52) U.S. Cl. CPC H04N 21/8153; H04N 21/23424; H04N 21/42653; H04N 21/44016; H04N 21/6587; H04N 21/812; H04N 21/47217

(57) ABSTRACT

Apparatuses, methods and storage medium associated with content distribution and consumption, are disclosed herein. In embodiments, the apparatus may include a media player configured to play the media content and secondary content associated with secondary content presentation slots of the media content, including fast-forward or skip the playing of the media content and the playing of the secondary content, in response to a fast-forward request. Further, the media player may be configured play tertiary content when playing of the secondary content is being fast-forwarded or skipped. Other embodiments may be described and/or claimed.

### TECHNICAL FIELD

The present disclosure relates to the field of data processing, in particular, to apparatuses, methods and storage medium associated with distribution and consumption of content, including presentation of tertiary content, when playing of secondary content is being fast-forwarded or skipped.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Advances in computing, networking and related technologies have led to proliferation in the availability of multi-media contents, and the manners the contents are consumed. Today, multi-media contents may be available from fixed medium (e.g., Digital Versatile Disk (DVD)), broadcast, cable operators, satellite channels, Internet, and so forth. User may consume contents with a wide range of content consumption devices, such as, television set, tablet, laptop or desktop computer, smartphone, or other stationary or mobile devices of the like.

A significant conflict continues to exist between content providers and content consumers is the provision and viewing of secondary content, such as, commercials or advertisements, provided with the primary content, e.g., a television program or a movie. Content providers of the primary content often want the content consumers to watch the secondary content. However, content consumers often prefer to skip the secondary content, e.g., via fast-forwarding, on platforms, such as televisions or digital recorders, where fast-forwarding is available.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an arrangement for content distribution and consumption with tertiary content, in accordance with various embodiments.

FIG. 2 illustrates an example content stream in further detail, in accordance with various embodiments.

FIG. 3 illustrates an example process for presenting tertiary content, in accordance with various embodiments.

FIG. 4 illustrates an example computing environment suitable for practicing the disclosure, in accordance with various embodiments.

FIG. 5 illustrates an example storage medium with instructions configured to enable an apparatus to practice the present disclosure, in accordance with various embodiments.

FIGS. 6-8 illustrate example tertiary content of the present disclosure, in accordance with various embodiments.

### DETAILED DESCRIPTION

Apparatuses, methods and storage medium associated with content distribution and consumption, are disclosed herein. In embodiments, an apparatus, e.g., a set-top box, may include a media player configured to play a media content and secondary content associated with secondary content presentation slots of the media content, including fast-forward or skip the playing of the media content and the playing of the secondary content, in response to a fast-forward or skip request. Further, the media player may be configured play tertiary content when playing of the secondary content is being fast-forwarded or skipped. An example of secondary content may be commercials of particular lengths, such as 60 seconds or 30 seconds, whereas examples of tertiary content may include a static image or an animation, having a logo, a trademark, or a theme, related to the secondary content. Another example of tertiary content may be an abbreviated version, e.g., 5 or 10 seconds of the longer secondary content.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous. The description may use the terms “fast-forward,” “skip,” and their variants. For the purpose of this application, including the claims, the terms are considered interchangeable, as the terms effectively include each other. For example, typically media content are played in 30 frames per second, thus a 3 second content has about 90 frames. Therefore, if the content is being fast-forwarded at a rate of 90 frames per sec, effectively the content is being “skipped.” Accordingly, “skipping” a content can be effectively viewed as a special case of very fast-forwarding of the content. Similarly, “fast-forwarding” can be effectively viewed as a special case of slow-motion “skipping.” Thus, all usage of either term in the remainder of the application, including in the claims, are intended to include the other term, unless the context clearly indicated otherwise.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

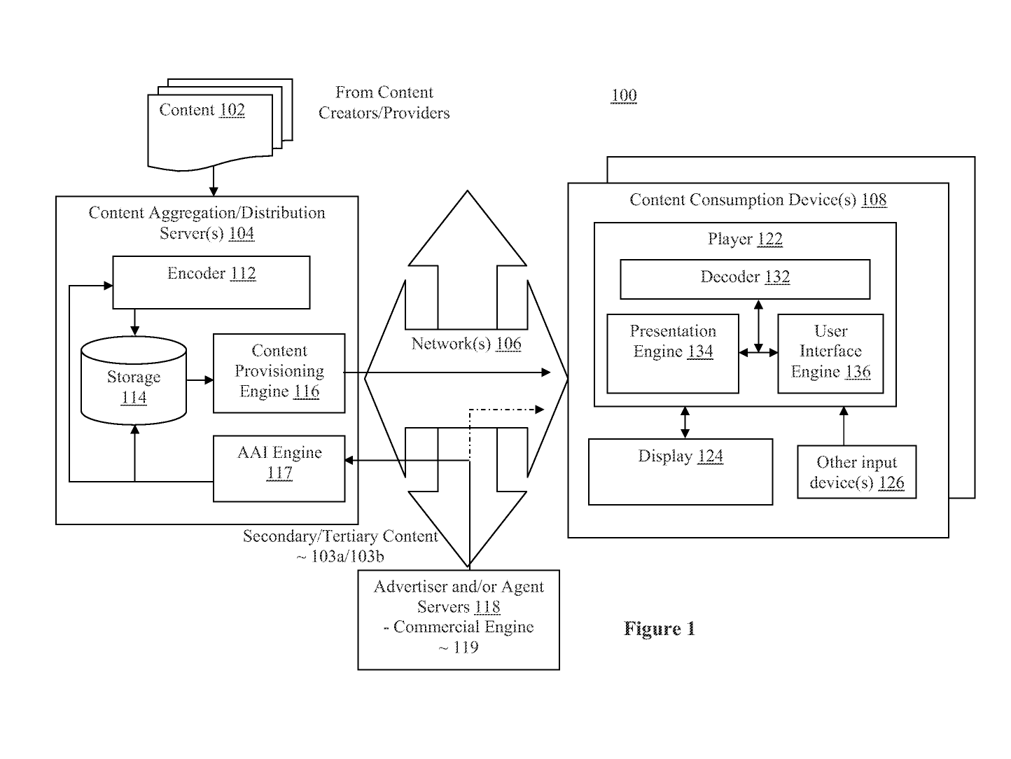

Referring now FIG. 1, wherein an arrangement for content distribution and consumption with tertiary content, in accordance with various embodiments, is illustrated. As shown, in embodiments, arrangement 100 for distribution and consumption of content may include a number of content consumption devices 108 coupled with one or more content aggregation/distribution servers 104 via one or more networks 106. Content aggregation/distribution servers 104 and/or content consumption devices 108 may also be coupled with advertiser/agent servers 118, via one or more networks 106. Content aggregation/distribution servers 104 may be configured to aggregate and distribute contents 102, such as television programs or movies, to content consumption devices 108 for consumption, via one or more networks 106. Content aggregation/distribution servers 104 may also be configured to cooperate with advertiser/agent servers 118 to integrally or separately provide secondary content 103a, e.g., commercials or advertisements, to content consumption devices 108. Content consumption devices 108 in turn may be configured to play content 102, and the secondary content 103a, for consumption by users of content consumption devices 108. By virtual of secondary nature of content 103a, thus content 102 may also be referred to as primary content 102. In embodiments, content consumption devices 108 may be configured to support fast-forwarding the playing of primary content 102 and secondary content 103a, in response to fast-forwarding requests from the users. Further, content consumption devices 108 may be configured to cooperate with content aggregation/distribution servers 104 and/or advertiser/agent servers 118 to receive, and play tertiary content 103b, when playing of secondary content is being fast-forwarded. Examples of tertiary content 103b may include, but are not limited to, a static image or animation having a logo, a trademark, or a theme related to secondary content 103a being fast-forwarded. Another example of tertiary content 103b may be a shortened version of secondary content 103a being fast-forwarded. Thus, incorporated with tertiary content playing teachings of the disclosure, arrangement 100 may better balance between the competing interest of content providers wanting the user to view secondary content 103a, and users who want to skip secondary content 103a. These and other aspects will be described more fully below.

Continuing to refer to FIG. 1, in embodiments, as shown, content aggregation/distribution servers 104 may include encoder 112, storage 114, content provisioning engine 116, and advertiser/agent interface (AAI) engine 117, coupled with each other as shown. Encoder 112 may be configured to encode content 102 from various content providers. Encoder 112 may also be configured to encode secondary/tertiary content 103a/103b from advertiser/agent servers 118. Storage 114 may be configured to store encoded content 102. Similarly, storage 114 may also be configured to store encoded secondary/tertiary content 103a/103b. Content provisioning engine 116 may be configured to selectively retrieve and provide, e.g., stream, encoded content 102 to the various content consumption devices 108, in response to requests from the various content consumption devices 108. Content provisioning engine 116 may also be configured to provide secondary and/or tertiary content 103a/103b to the various content consumption devices 108. Thus, except for its cooperation with advertiser/agent servers 118 and/or content consumption devices 108, incorporated with the tertiary content teachings of the present disclosure, content aggregation/distribution servers 104 are intended to represent a broad range of such servers known in the art. Examples of content aggregation/distribution servers 104 may include, but are not limited to, servers associated with content aggregation/distribution services, such as Netflix, Hulu, Comcast, Direct TV, Aereo, YouTube, Pandora, and so forth.

Contents 102 may be multi-media contents of various types, having video, audio, and/or closed captions, from a variety of content creators and/or providers. Examples of contents may include, but are not limited to, movies, TV programming, user created contents (such as YouTube video, iReporter video), music albums/titles/pieces, and so forth. Examples of content creators and/or providers may include, but are not limited to, movie studios/distributors, television programmers, television broadcasters, satellite programming broadcasters, cable operators, online users, and so forth. As described earlier, secondary content 103a may be a broad range of commercials or advertisements known in the art, whereas tertiary content 103b may include, but are not limited to, static images or animations having logos, trademarks, or themes related to secondary content 103a being fast forwarded. Another example of tertiary content 103b may be shortened versions of secondary content 103a being fast-forwarded.

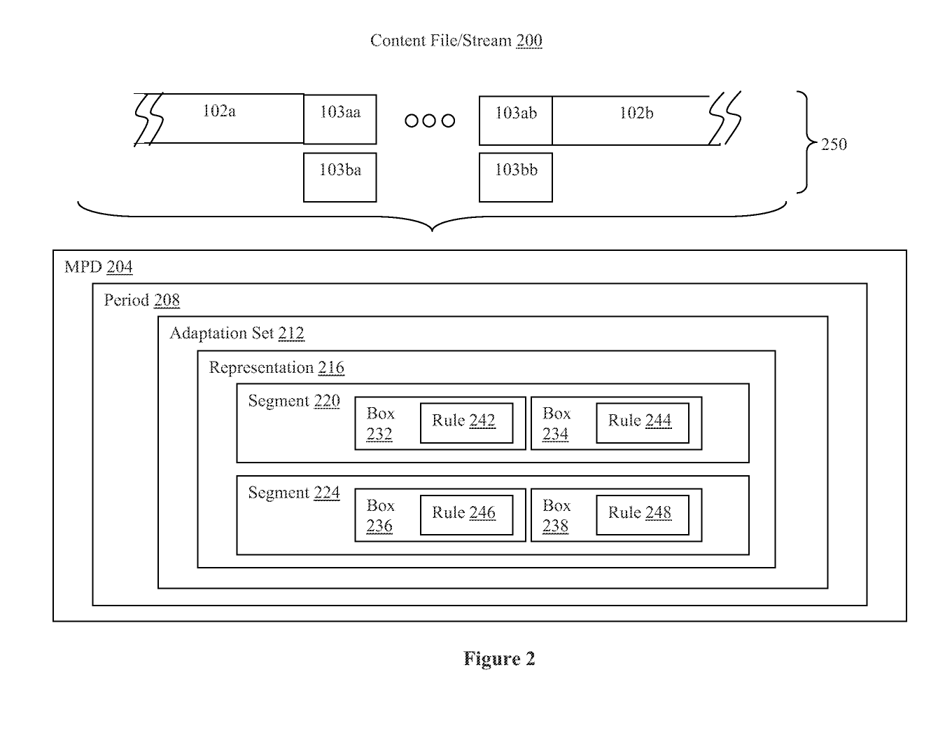

In embodiments, for efficiency of operation, encoder 112 may be configured to transcode various content 102, secondary content 103a, and tertiary content 103b, typically in different encoding formats, into a subset of one or more common encoding formats. Referring now also to FIG. 2, wherein an example content file/stream, in accordance with various embodiments, is illustrated. Encoder 112 may also be configured to transcode various content 102 into content segments 102a/102b, allowing for secondary content 103a to be presented in various secondary content presentation slots 103aa/103ab in between any two content segments 102/102b (as illustrated by 250). Additionally, if desired, a secondary content 103aa/103ab may be paired with corresponding tertiary content 103ba/103bb to be played, when playing of the corresponding secondary content 103aa/103ab is being fast forwarded. Encoding of audio data may be performed in accordance with, e.g., but are not limited to, the MP3 standard, promulgated by the Moving Picture Experts Group (MPEG), or the Advanced Audio Coding (AAC) standard, promulgated by the International Organization for Standardization (ISO). Encoding of video and/or audio data may be performed in accordance with, e.g., but are not limited to, the H264 standard, promulgated by the International Telecommunication Unit (ITU) Video Coding Experts Group (VCEG), VP9, the open video compression standard promulgated by Google® of Mountain View, Calif.

Referring back to FIG. 1, and continuing with the description of content aggregate/distribution servers 104, storage 114 may be temporal and/or persistent storage of any type, including, but are not limited to, volatile and non-volatile memory, optical, magnetic and/or solid state mass storage, and so forth. Volatile memory may include, but are not limited to, static and/or dynamic random access memory. Non-volatile memory may include, but are not limited to, electrically erasable programmable read-only memory, phase change memory, resistive memory, and so forth.

Content provisioning engine 116 may, in various embodiments, be configured to provide encoded content 102, secondary and tertiary content 103a/103b, as discrete files and/or as continuous streams of encoded content 102, secondary and tertiary content 103a/103b. Content provisioning engine 116 may be configured to transmit the encoded audio/video data (and closed captions, if provided) in accordance with any one of a number of streaming and/or transmission protocols. The streaming protocols may include, but are not limited to, the Real-Time Streaming Protocol (RTSP). Transmission protocols may include, but are not limited to, the transmission control protocol (TCP), user datagram protocol (UDP), and so forth.

In embodiments, content 102, secondary content 103a and tertiary content 103b may be integrally provided to content consumption devices 108 in a combined discrete file or a single stream (see e.g., 250 of FIG. 2). In other embodiments, content 102 and secondary content 103a may be integrally provided to content consumption devices 108 in a combined discrete file or a single stream, with tertiary content 103b separately provided. In still other embodiments, content 102, secondary content 103a, and tertiary may be separately provided to content consumption devices 108.

For the integrally provided embodiments, secondary and/or tertiary content 103a/103b may be provided to a content consumption device 108, as part of the response to a request for content 102 from the content consumption device 108. For the separately provided embodiments, secondary and/or tertiary content 103a/103b may be provided to a content consumption device 108, in response to a request for the secondary/tertiary content 103a/103b from the content consumption device 108, subsequent to the initial request for content 102 (e.g., when the content consumption devices 108 detected that playing of secondary content 103a is being fast-forwarded). For the separately provided embodiments, as an alternative, secondary and/or tertiary content 103a/103b may also be provided to a content consumption device 108, directly from advertiser/agent servers 118 (as denoted by the dotted line emanating from server 118 to devices 108). Advertiser/agent servers 118 may be configured to provide secondary and/or tertiary content 103a/103b in response to a request for the secondary/tertiary content 103a/103b from a content consumption device 108, or in response to a notice/request from content aggregation/distribution server(s) 104. For example, content aggregation/distribution server(s) 104 may notify/request one or more advertiser/agent servers 118 to provide secondary/tertiary content 103a/103b to a content consumption device 108, on receipt for a request for content 102 from the content consumption device 108.

In embodiments where secondary/tertiary contents 103a/103b are provided to content consumption devices 108 from content aggregation/distribution servers 104, AAI engine 117 may be configured to interface with advertiser and/or agent servers 118 to receive secondary and/or tertiary content 103a/103b. On receipt, AAI engine 117 may route the received secondary and/or tertiary content 103a/103b to encoder 112 for transcoding as earlier described, and then stored into storage 114. Additionally, in embodiments, AAI engine 117 may be configured to interface with advertiser and/or agent servers 118 to receive audience targeting selection criteria (not shown) from sponsors of secondary and/or tertiary content 103a/103b. Examples of targeting selection criteria may include, but are not limited to, demographic and interest of the users of content consumption devices 108. Further, AAI engine 117 may be configured to store the audience targeting selection criteria in storage 114, for subsequent use by content provisioning engine 116.

In embodiments, encoder 112, content provisioning engine 116 and AAI engine 117 may be implemented in any combination of hardware and/or software. Example hardware implementations may include Application Specific Integrated Circuits (ASIC) endowed with the operating logic, or programmable integrated circuits, such as Field Programmable Gate Arrays (FPGA) programmed with the operating logic. Example software implementations may include logic modules with instructions compilable into the native instructions supported by the underlying processor and memory arrangement (not shown) of content aggregation/distribution servers 104.

Referring now to FIG. 2 again, as described earlier, content 102 may be encoded by encoder 112 into different versions. In embodiments, the different versions may have different bit rates, channels, sizes, or some other parameter which may generally or collectively referred to as a QoS parameter defining a QoS level. Each version of the encoded content stream 200 may be divided into discrete segments, e.g., 102a, 102b, which can then be selectively requested by the content consumption device 108. For example, the content consumption device 108 may request content segments 102a/102b with particular QoS parameters, via hypertext transfer protocol (HTTP) or some other internet protocol to content aggregation/distribution servers 104. In turn, content aggregation/distribution servers 104 may respond with the requested content segment 102a/102b.

In embodiments, the encoded content file/stream 200 may include a media presentation description (MPD) 204 document. The MPD 204 may describe a sequence of periods 208 that represent a content period during which a consistent set of encoded versions of the content is available. In other words, the set of available bitrates, languages, captions, subtitles, or other QoS parameters or QoS levels may remain unchanged during the period 208. Although only a single period 208 is depicted in FIG. 2, other embodiments may have an MPD 204 with multiple periods, each having different available bitrates, languages, captions, subtitles, or other QoS parameters or QoS levels.

Within a period 208, the content may be arranged into adaptation sets 212. The adaptation set 212 may represent a set of interchangeable encoded versions of one or several content components such as a video component, an audio component, etc. Other components such as captions or audio descriptions may likewise have a separate adaptation set 212. Although only a single adaptation set 212 is shown in FIG. 2, in other embodiments each period 208 may comprise a plurality of adaptation sets 212.

Each adaptation set 212 may comprise one or more representations 216. A representation may describe the deliverable encoded versions of one or several content components of the content 102, secondary content 103a, interleaved in between segments of content 102, and tertiary content 103b, to be played when playing of secondary content 103a is being fast-forwarded. For example, a representation 216 may include one or more streams for each content component such as audio components, video components, captions, or audio descriptions of the primary 102, secondary 103a, or tertiary content 103b. In general, any single representation 216 within an adaptation set 212 may be sufficient to render the contained content components. In embodiments, each adaptation set 212 may include a plurality of representations 216.

Each representation 216 may be divided into one or more segments 220 and 224. In general, a segment 220 and 224 may be considered to be the largest unit of the encoded content file/stream 200 that may be retrieved by a single HTTP request. In embodiments, the segment 220 may have a different length or duration than segment 224. In some embodiments, the segment length may vary between representations such that the length of segment 220 and 224 in representation 216 may be on the order of a few seconds, while in another representation the length of a segment may be as long as the length of the representation or some value in between.

In embodiments, each segment, such as segment 220 or segment 224, may be encoded according to an ISO base media file format such as that defined in ISO/IEC 14496-12:2012. Specifically, each segment such as segment 220 or segment 224 may comprise a plurality of boxes 232 and 234 or 236 and 238 respectively. In some embodiments the boxes 232-238, may comprise one or more presentation rules 242-248, that governs the presentation of one or more segments. In embodiments, some of the one or more presentation rules 242-248 may be associated with the corresponding secondary and/or tertiary content 103a/103b, and governs presentation of the corresponding secondary and/or tertiary content 103a/103b. The rules may also be referred as policies. In embodiments, the rules or policies may be provided to the content consumption devices 108 separately (as opposed to integrally), via, e.g., a manifest, separate from the content file/stream 200. In either case, in embodiments, decoder 132 of media player 122 of a content consumption device 108, or some other component, may be configured to receive the policies separately or extract the policies from the content file/stream 200, and process them for use by presentation engine 134 of media player 122.

Still referring to FIG. 1, advertiser and/or agent servers 118 may include commercial engine 119. In embodiments, commercial engine 119 may be configured to provide content aggregation/distribution servers 104 with secondary and/or tertiary content 103a/103b. Commercial engine 119 may also be configured to provide audience targeting selection criteria for secondary and/or tertiary content 103a/103b to content aggregation/distribution servers 104.

In embodiments, commercial engine 119 may be implemented in any combination of hardware and/or software. Example hardware implementations may include Application Specific Integrated Circuits (ASIC) endowed with the operating logic, or programmable integrated circuits, such as Field Programmable Gate Arrays (FPGA) programmed with the operating logic. Example software implementations may include logic modules with instructions compilable into the native instructions supported by the underlying processor and memory arrangement (not shown) of advertiser/agent servers 118.

Networks 106 may be any combination of private and/or public, wired and/or wireless, local and/or wide area networks. Private networks may include, e.g., but are not limited to, enterprise networks. Public networks, may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that at the content aggregation/distribution servers' end or advertiser/agent servers' end, networks 106 may include one or more local area networks with gateways and firewalls, through which servers 104/118 go through to communicate with each other, and with content consumption devices 108. Similarly, at the content consumption end, networks 106 may include base stations and/or access points, through which content consumption devices 108 communicate with servers 104/118. In between the different ends, there may be any number of network routers, switches and other networking equipment of the like. However, for ease of understanding, these gateways, firewalls, routers, switches, base stations, access points and the like are not shown.

In embodiments, as shown, a content consumption device 108 may include player 122, display 124 and user input device 126, coupled with each other as shown. Further, a content consumption device 108 may also include local storage (not shown). Player 122 may be configured to receive encoded content 102, decode and recovered content 102, and present the recovered content 102 on display 124, in response to user selections/inputs from user input device 126. Further, player 122 may be configured to receive secondary content 103a, decode and recovered secondary content 103a, and present the recovered secondary content 103a on display 124, at the corresponding secondary content presentation slots. Still further, player 122 may be configured to receive tertiary content 103b, decode and recovered tertiary content 103b, and present the recovered tertiary content 103b on display 124, when playing of the corresponding secondary content 103a is being fast-forwarded. Local storage (not shown) may be configured to store/buffer content 102, and secondary/tertiary content 103a/103b, as well as working data of player 122.

In embodiments, player 122 may include decoder 132, presentation engine 134 and user interface engine 136, coupled with each other as shown. Decoder 132 may be configured to receive content 102, and secondary/tertiary content 103a/103b, decode and recover content 102, and secondary/tertiary content 103a/103b. Presentation engine 134 may be configured to present content 102 with secondary content 103a on display 124, in response to user controls, e.g., stop, pause, fast-forward, rewind, and so forth. In embodiments, presentation engine 134 may be configured to present tertiary content 103b on display 124, when the playing of secondary content 103a is being fast-forwarded. User interface engine 136 may be configured to receive selections/controls from a content consumer (hereinafter, also referred to as the “user”), and in turn, provide the user selections/controls to decoder 132 and/or presentation engine 134.

While shown as part of a content consumption device 108, display 124 and/or user input device(s) 126 may be standalone devices or integrated, for different embodiments of content consumption devices 108. For example, for a television arrangement, display 124 may be a stand-alone television set, Liquid Crystal Display (LCD), Plasma and the like, while player 122 may be part of a separate set-top set or a digital recorder, and other user input device 126 may be a separate remote control or keyboard. Similarly, for a desktop computer arrangement, player 122, display 124 and other input device(s) 126 may all be separate stand-alone units. On the other hand, for a laptop, ultrabook, tablet or smartphone arrangement, player 122, display 124 and other input devices 126 may be integrated together into a single form factor. Further, for tablet or smartphone arrangement, a touch sensitive display screen may also server as one of the other user input device(s) 126, and player 122 may be a computing platform with a soft keyboard that also include one of the user input device(s) 126.

In embodiments, decoder 132, presentation engine 134 and user interface engine 136 may be implemented in any combination of hardware and/or software. Example hardware implementations may include Application Specific Integrated Circuits (ASIC) endowed with the operating logic, or programmable integrated circuits, such as Field Programmable Gate Arrays (FPGA) programmed with the operating logic. Example software implementations may include logic modules with instructions compilable into the native instructions supported by the underlying processor and memory arrangement (not shown) of content consumption devices 108. Thus, except for its cooperation with content aggregation/distribution server 104 and/or advertiser/agent server 118, content consumption devices 108 are also intended to otherwise represent a broad range of these devices known in the art including, but are not limited to, media player, game console, and/or set-top box, such as Roku streaming player from Roku of Saratoga, Calif., Xbox, from Microsoft Corporation of Redmond, Wash., Wii from Nintendo of Kyoto, Japan, desktop, laptop or tablet computers, such as those from Apple Computer of Cupertino, Calif., or smartphones, such as those from Apple Computer or Samsung Group of Seoul, Korea.

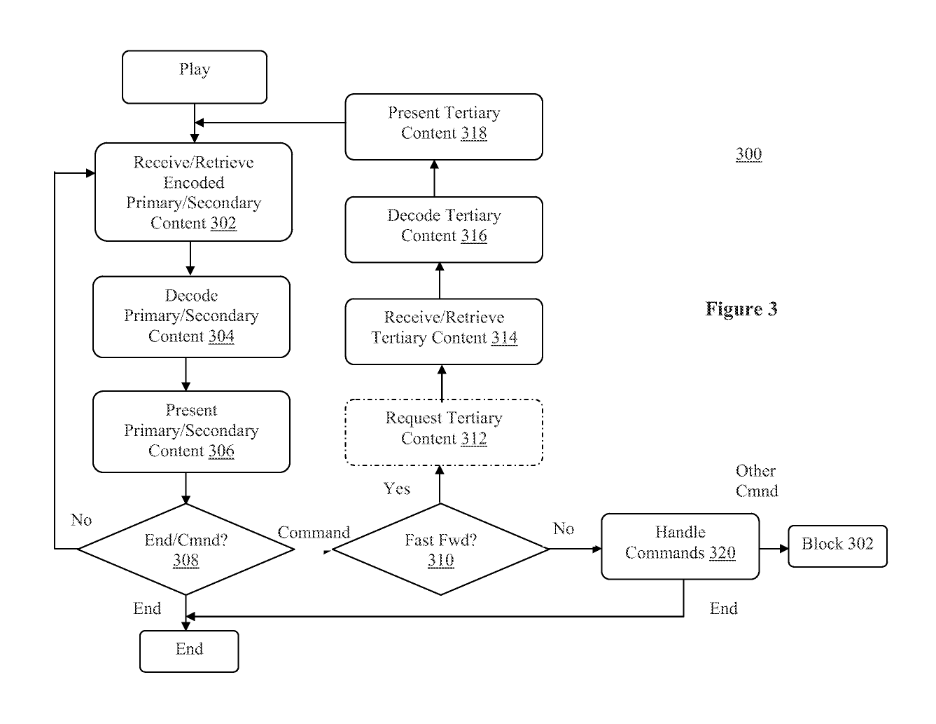

Referring now to FIG. 3, wherein an example process for playing tertiary content, which may be practiced on a content consumption device 108, in accordance with various embodiments, is illustrated. As shown, process 300 may include operations at blocks 302-320. Operations within blocks 302-320 may be cooperatively performed, e.g., by selected ones of the earlier described decoder 132, presentation engine 134, and user interface engine 136 of a content consumption device 108. While for ease of understanding, the various operations are being described as performed by the various example components, in alternate embodiments, the operations may be distributed differently, with some of the components combined or sub-divided.

At blocks 302-306, process 300 may receive or retrieve encoded primary/secondary content, decode and recover primary/secondary content, and present the recovered primary/secondary content, as earlier described. In embodiments, process 300 may receive the primary content in real time from a content distributor, e.g., a content aggregate/distribution server 104, and receive the secondary content in real time from a content distributor, e.g., a content aggregate/distribution server 104, or a secondary content provider, e.g., an advertiser/agent server 118. In other embodiments, where the primary/secondary content have been pre-provided, process 300 may retrieve the primary and/or second content from the local storage.

While receiving, decoding, recovering, and presenting primary/secondary content, process 300 may proceed to block 308. At block 308, process 300 may determine whether the end of primary content has been reached or a user command (Cmnd) has been received (including possibly, an “end play” command). If the end of primary content has not been reached, and no user command has been received, process 300 may return to block 302 and continue as earlier described.

If the end of primary content has been reached, or an “end play” command has been received, process 300 may terminate. If the end of primary content has not been reached, and a user command has been received, process 300 may proceed to block 310.

At block 310, process 300 may determine whether a fast-forward command has been received. If a fast-forward command has been received, process 300 may optionally proceed to block 312, then block 314, or to block 314 directly. In embodiments where tertiary content are not pre-provided, process may proceed to block 312, where a request for the tertiary content may be made, e.g., with content aggregation/distribution servers 104. Thereafter, process 300 may proceed to block 314. In embodiments where the tertiary content are pre-provided, process may proceed to block 314 directly. At block 314, with or without going through optional block 312, encoded tertiary content may be received or retrieved.

From block 314, process 300 may proceed to blocks 316-318. At block 316, process 300 may decode and recover tertiary content. At block 318, process 300 may play the recovered tertiary content corresponding to the secondary content being fast-forwarded. From block 318, process may return to block 302, and continue as earlier described.

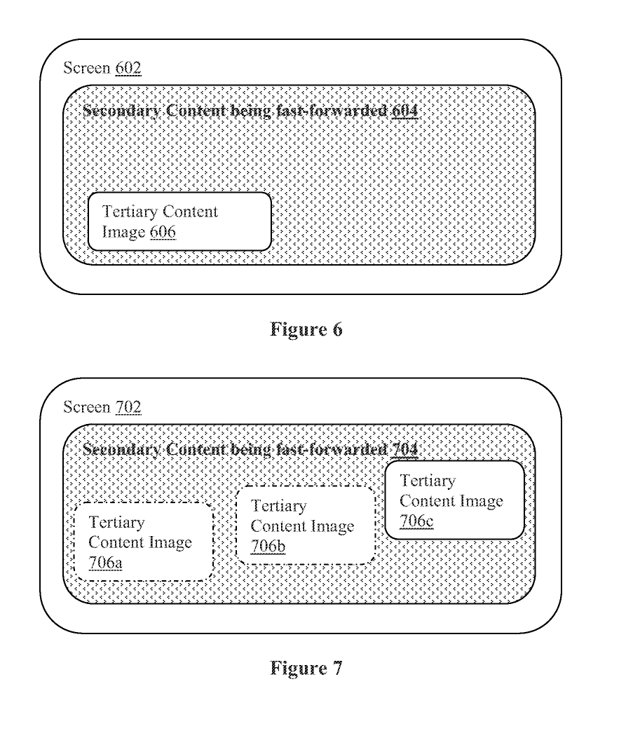

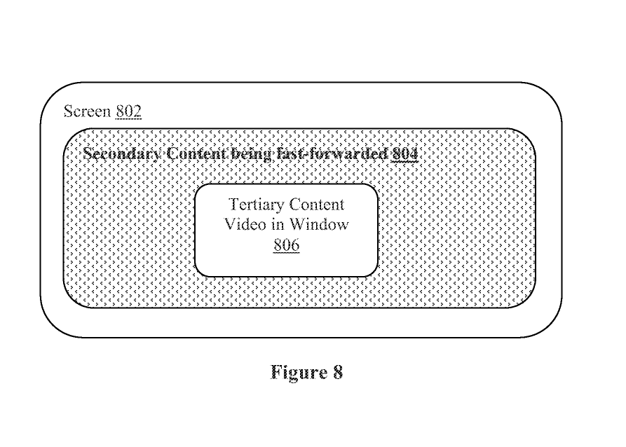

Referring now to FIGS. 6-8, wherein example playing of tertiary content, in accordance with various embodiments, are illustrated. As shown in FIG. 6, and described earlier, a tertiary content may be a static image, such as image 606, rendered on screen 602, superimposed on the secondary content being fast-forwarded 604. Image 606 may include, e.g., a logo, a trademark, or a theme related to the secondary content being fast-forwarded 604. As shown in FIG. 7, and described earlier, a tertiary content may be an animation, such as the animation having the example sequence of images 706a-706c, rendered on screen 702, superimposed on the secondary content being fast-forwarded 704. The dotted boundary lines of images 706a-706b, together with the solid boundary line of image 706c, are intended to depict an animation of image 706* moving across screen 602 (706* means 706a, 706b or 706c). As shown in FIG. 8, and described earlier, a tertiary content 806 may be a shortened version of the secondary content being fast-forwarded 804, rendered within a window on screen 802, superimposed on the secondary content being fast-forwarded 804. As described earlier, e.g., the secondary content being fast-forwarded 804 may be a 30 seconds or 60 seconds commercial, whereas the tertiary content 806 may be a shortened 5 or 10 seconds version. Further, in embodiments, in each case, static image 606, animated image instance 706a-706c or video window with a shortened version of tertiary content 806, may itself be clickable or have associated icons that are clickable, for the user to click for more information about a product, a service or the sponsor, click to obtain a coupon for a product or service, click to dismiss all further tertiary content from the same sponsor, and so forth. For these embodiments, process 300 may further include operations associated with responding to the clicks, providing the additional information about the product, the service or the sponsor, providing the requested coupon, and ceasing further provision of tertiary content of the sponsor.

Referring now back to FIG. 3, at block 310, if the user command received is not the fast-forward command, but some other command, such as, a pause, a rewind, or some other command instead, process 300 may proceed to block 320 instead. At block 320, process 300 may handle the “other” command, pausing, rewinding . . . the playing of the primary and secondary contents, as known in the art. On handling the “other” command, process 300 may return to block 302, and continue as earlier described.

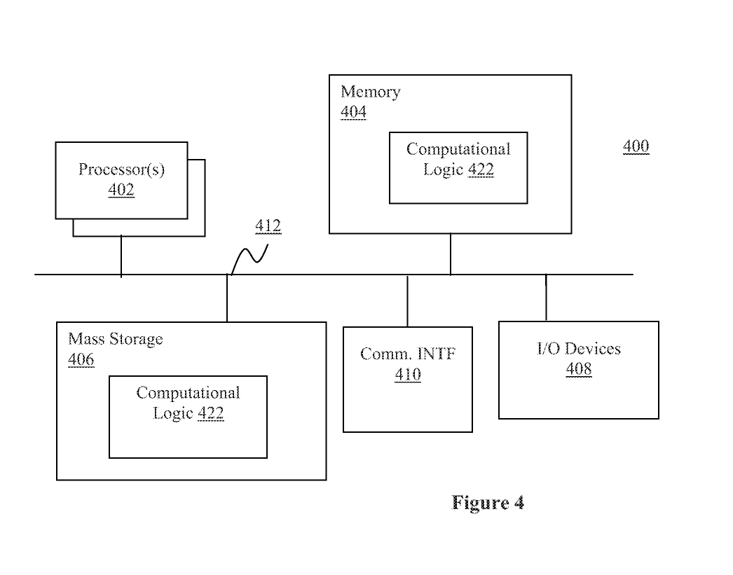

Referring now to FIG. 4, wherein an example computer suitable for use for the arrangement of FIG. 1, in accordance with various embodiments, is illustrated. As shown, computer 400 may include one or more processors or processor cores 402, and system memory 404. For the purpose of this application, including the claims, the terms “processor” and “processor cores” may be considered synonymous, unless the context clearly requires otherwise. Additionally, computer 400 may include mass storage devices 406 (such as diskette, hard drive, compact disc read only memory (CD-ROM) and so forth), input/output devices 408 (such as display, keyboard, cursor control and so forth) and communication interfaces 410 (such as network interface cards, modems and so forth). The elements may be coupled to each other via system bus 412, which may represent one or more buses. In the case of multiple buses, they may be bridged by one or more bus bridges (not shown).

Each of these elements may perform its conventional functions known in the art. In particular, system memory 404 and mass storage devices 406 may be employed to store a working copy and a permanent copy of the programming instructions implementing the operations associated with content aggregation/distribution servers 104, content consumption devices 108 or advertiser/agent servers 118, earlier described, in particular, the operations associated with providing, distributing and presenting tertiary content, collectively referred to as computational logic 422. The various elements may be implemented by assembler instructions supported by processor(s) 402 or high-level languages, such as, for example, C, that can be compiled into such instructions.

The permanent copy of the programming instructions may be placed into permanent storage devices 406 in the factory, or in the field, through, for example, a distribution medium (not shown), such as a compact disc (CD), or through communication interface 410 (from a distribution server (not shown)). That is, one or more distribution media having an implementation of the agent program may be employed to distribute the agent and program various computing devices.

The number, capability and/or capacity of these elements 410-412 may vary, depending on whether computer 400 is used as a content aggregation/distribution server 104, a content consumption device 108, or an advertiser/agent server 118. When use as content consumption device 108, the capability and/or capacity of these elements 410-412 may vary, depending on whether the content consumption device 108 is a stationary or mobile device, like a smartphone, computing tablet, ultrabook or laptop. Otherwise, the constitutions of elements 410-412 are known, and accordingly will not be further described.

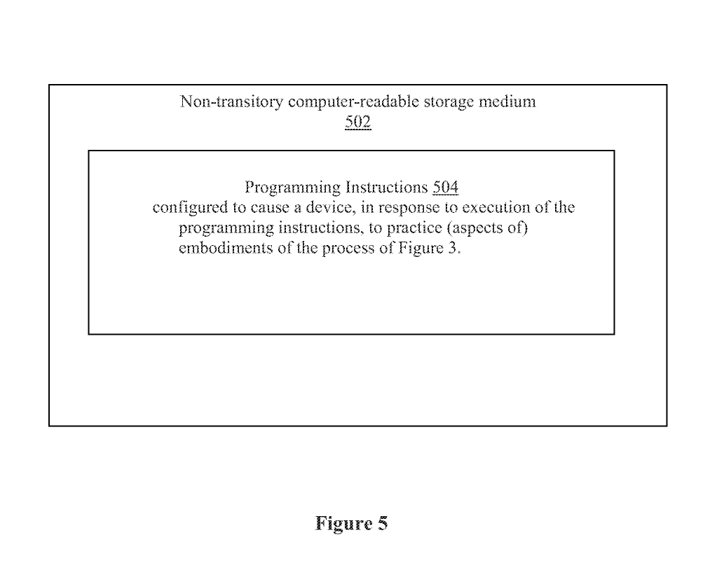

FIG. 5 illustrates an example computer-readable non-transitory storage medium having instructions configured to practice all or selected ones of the operations associated with content aggregation/distribution servers 104, content consumption devices 108, or advertiser/agent servers 118, earlier described; in accordance with various embodiments. As illustrated, non-transitory computer-readable storage medium 502 may include a number of programming instructions 504. Programming instructions 504 may be configured to enable a device, e.g., computer 400, in response to execution of the programming instructions, to perform, e.g., various operations described with references to FIGS. 1-2 or operations of process 300 of FIG. 3, e.g., but not limited to, the operations associated with providing, distributing and playing of tertiary content. In alternate embodiments, programming instructions 504 may be disposed on multiple computer-readable non-transitory storage media 502 instead. In alternate embodiments, programming instructions 504 may be disposed on computer-readable transitory storage media 502, such as, signals.

Referring back to FIG. 4, for one embodiment, at least one of processors 402 may be packaged together with memory having computational logic 422 (in lieu of storing on memory 404 and storage 406). For one embodiment, at least one of processors 402 may be packaged together with memory having computational logic 422 to form a System in Package (SiP). For one embodiment, at least one of processors 402 may be integrated on the same die with memory having computational logic 422. For one embodiment, at least one of processors 402 may be packaged together with memory having computational logic 422 to form a System on Chip (SoC). For at least one embodiment, the SoC may be utilized in, e.g., but not limited to, a set-top box.

Thus various example embodiments of the present disclosure have been described including, but are not limited to:

Example 1 may be an apparatus for playing media content. The apparatus may include a media player to play the media content and secondary content associated with secondary content presentation slots of the media content, including fast-forward the playing of the media content and the playing of the secondary content, in response to a fast-forward request. Further, the media player may play tertiary content when playing of the secondary content is being fast-forwarded.

Example 2 may be example 1, wherein the tertiary content may include a static image having content related to the secondary content being fast-forwarded, and the media player to render the static image, superimposed on top of the secondary content being fast-forwarded.

Example 3 may be example 1 or 2, wherein the tertiary content may include a sequence of images having content related to the secondary content being fast-forwarded, the media player to render the sequence of images, forming an animation, superimposed on top of the secondary content being fast-forwarded.

Example 4 may be any one of examples 1-3, wherein the tertiary content may include a video that is a shortened version of the secondary content being fast-forwarded, and the media player to play the video in a window, superimposed on top of the secondary content being fast-forwarded.

Example 5 may be any one of examples 1-4, wherein the media player to integrally receive the media content, the secondary content and the tertiary content in one content stream.

Example 6 may be any one of examples 1-5, wherein the media player to separately receive at least the tertiary content.

Example 7 may be any one of examples 1-6, wherein the media player to further request for the tertiary content, in response to the fast-forward request.

Example 8 may be any one of examples 1-7, further having a storage coupled to the media player to store the media content, the secondary content and the tertiary content.

Example 9 may be any one of examples 1-8, wherein the media player may include: a decoder to receive and decode the media content, the secondary content and the tertiary content; a presentation engine coupled with the decoder to present the decoded media content, secondary content, and tertiary content; and a user interface engine coupled to the presentation engine to receive the fast-forward request from a user, and provide the fast-forward request to the presentation engine.

Example 10 may be any one of examples 1-9, wherein the apparatus may include a selected one of a smartphone, a computing tablet, a netbook, an e-reader, a laptop computer, a desktop computer, a game console or a set-top box.

Example 11 may be a method for consuming content. The method may include playing, by a media player of a content consumption device, media content and secondary content associated with secondary content presentation slots of the media content; and fast-forwarding, by the media player, the playing of the media content and the playing of the secondary content, in response to a fast-forward request. The method may further include playing, by the media player, tertiary content, when playing of the secondary content is being fast-forwarded.

Example 12 may be example 11, wherein the tertiary content may include a static image having content related to the secondary content being fast-forwarded, and playing tertiary content may include rendering the static image, superimposed on top of the secondary content being fast-forwarded, or wherein the tertiary content may include a sequence of images having content related to the secondary content being fast-forwarded, and playing tertiary content may include rendering the sequence of images, forming an animation, superimposed on top of the secondary content being fast-forwarded.

Example 13 may be example 11 or 12, wherein the tertiary content may include a video that is a shortened version of the secondary content being fast-forwarded, and playing tertiary content may include playing the video in a window, superimposed on top of the secondary content being fast-forwarded; or wherein the tertiary content has a sponsor, and is clickable, and the method further may include ceasing further playing of tertiary content from the same sponsor.

Example 14 may be any one of examples 11-13, further having integrally receiving, by the media player, the media content, the secondary content and the tertiary content in one content stream, or separately receiving, by the media player, at least the tertiary content.

Example 15 may be any one of examples 11-14, further having requesting, by the media player, for the tertiary content, in response to the fast-forward request.

Example 16 may be one or more computer readable medium having instructions to cause a computing device, in response to execution of the instructions by the computing device, to perform any one of the methods of examples 11-15.

Example 17 may be an apparatus for playing media content. The apparatus may include means for playing the media content and secondary content associated with secondary content presentation slots of the media content, including fast-forward the playing of the media content and the playing of the secondary content, in response to a fast-forward request; and means for playing tertiary content when playing of the secondary content is being fast-forwarded.

Example 18 may be example 17, wherein the tertiary content may include a static image having content related to the secondary content being fast-forwarded, and the media player to render the static image, superimposed on top of the secondary content being fast-forwarded; a sequence of images having content related to the secondary content being fast-forwarded, the media player to render the sequence of images, forming an animation, superimposed on top of the secondary content being fast-forwarded; or a video that is a shortened version of the secondary content being fast-forwarded, and the media player to play the video in a window, superimposed on top of the secondary content being fast-forwarded.

Example 19 may be an apparatus for providing content for consumption. The apparatus may include an engine to provide tertiary content for playing on a content consumption device; wherein the tertiary content is to be played while playing of secondary content of a media content is being fast-forwarded.

Example 20 may be example 19, wherein the apparatus may include a content aggregation/distribution server, and the engine may include a content provisioning engine; wherein the content provisioning engine to further provide the media and secondary content to the content consumption device.

Example 21 may be example 20, wherein the content provisioning engine to integrally provide the media content, the secondary content and the tertiary content in one content stream.

Example 22 may be example 20 or 21, wherein the content provisioning engine to separately provide at least the tertiary content.

Example 23 may be example 22, wherein the content provisioning engine to separately provide the tertiary content, in response to a request for the tertiary content.

Example 24 may any one of examples 19-23, wherein the apparatus may include an advertiser/agent server, and the engine may include a commercial engine to provide the tertiary content to the content consumption device directly, or via a content aggregation/distribution server.

Example 25 may be a method for providing content for consumption. The method may include providing, by a content provisioning engine of a content aggregation/distribution server or a commercial engine of an advertiser/agent server, tertiary content for playing on a content consumption device; wherein the tertiary content is to be played while playing of secondary content of a media content is being fast-forwarded.

Example 26 may be example 25, wherein providing is performed by the content aggregation/distribution server, and the method further may include providing, by the content provisioning engine, the media and secondary content to the content consumption device.

Example 27 may be example 26, wherein providing the tertiary content is performed separately from providing the media and secondary content; and wherein providing the tertiary content may include providing the tertiary content, in response to a request for the tertiary content.

Example 28 may be any one of examples 25-27, wherein providing the tertiary content is performed by the advertiser/agent server, and providing the tertiary content may include providing the tertiary content to the content consumption device directly, or via the content aggregation/distribution server.

Example 29 may be one or more computer readable medium having instructions to cause a computing device, in response to execution of the instructions by the computing device, to perform any one of the methods of examples 25-28. Example 30 may be an apparatus for providing content for consumption. The apparatus may include means for provide tertiary content for playing on a content consumption device; wherein the tertiary content is to be played while playing of secondary content of a media content is being fast-forwarded.

Example 31 may be example 30, wherein the apparatus may include a content aggregation/distribution server, and the means for provide tertiary content may include a content provisioning engine; wherein the content provisioning engine to further provide the media and secondary content to the content consumption device; or the apparatus may include an advertiser/agent server, and the means for provide tertiary content may include a commercial engine to provide the tertiary content to the content consumption device directly, or via a content aggregation/distribution server.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the examples.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus for playing media content, comprising:
a media player to play the media content and secondary content associated with secondary content presentation slots of the media content, including fast-forward the playing of the media content and the playing of the secondary content, in response to a fast-forward request, wherein the media player to further play tertiary content when playing of the secondary content is being fast-forwarded.

2. The apparatus of claim 1, wherein the tertiary content comprises a static image having content related to the secondary content being fast-forwarded, and the media player to render the static image, superimposed on top of the secondary content being fast-forwarded.

3. The apparatus of claim 1, wherein the tertiary content comprises a sequence of images having content related to the secondary content being fast-forwarded, the media player to render the sequence of images, forming an animation, superimposed on top of the secondary content being fast-forwarded.

4. The apparatus of claim 1, wherein the tertiary content comprises a video that is a shortened version of the secondary content being fast-forwarded, and the media player to play the video in a window, superimposed on top of the secondary content being fast-forwarded.

5. The apparatus of claim 1, wherein the media player to integrally receive the media content, the secondary content and the tertiary content in one content stream.

6. The apparatus of claim 1, wherein the media player to separately receive at least the tertiary content.

7. The apparatus of claim 1, wherein the media player to further request for the tertiary content, in response to the fast-forward request.

8. The apparatus of claim 1, further comprising a storage coupled to the media player to store the media content, the secondary content and the tertiary content.

9. The apparatus of claim 1, wherein the media player comprises:
a decoder to receive and decode the media content, the secondary content and the tertiary content;
a presentation engine coupled with the decoder to present the decoded media content, secondary content, and tertiary content; and
a user interface engine coupled to the presentation engine to receive the fast-forward request from a user, and provide the fast-forward request to the presentation engine.

10. The apparatus of claim 1, wherein the apparatus comprises a selected one of a smartphone, a computing tablet, a netbook, an e-reader, a laptop computer, a desktop computer, a game console or a set-top box.

11. One or more non-transitory computer-readable storage medium having a plurality of instructions, in response to execution of the instructions by a content consumption device, to cause the content consumption device to provide a media player to:
play media content and secondary content associated with secondary content presentation slots of the media content;
fast-forward the playing of the media content and the playing of the secondary content, in response to a fast-forward request; and
play tertiary content, when playing of the secondary content is being fast-forwarded.

12. The storage medium of claim 11, wherein the tertiary content comprises a static image having content related to the secondary content being fast-forwarded, and playing tertiary content comprises rendering the static image, superimposed on top of the secondary content being fast-forwarded, or wherein the tertiary content comprises a sequence of images having content related to the secondary content being fast-forwarded, and play tertiary content comprises render the sequence of images, to form an animation, superimposed on top of the secondary content being fast-forwarded.

13. The storage medium of claim 11, wherein the tertiary content comprises a video that is a shortened version of the secondary content being fast-forwarded, and play tertiary content comprises play the video in a window, superimposed on top of the secondary content being fast-forwarded; or wherein the tertiary content has a sponsor, and is clickable, and the media player to further cease play of tertiary content from the same sponsor.

14. The storage medium of claim 11, the media player to further integrally receive the secondary content and the tertiary content in one content stream, or separately receive at least the tertiary content.

15. The storage medium of claim 11, the media player to further request for the tertiary content, in response to the fast-forward request.

16. An apparatus for providing content for consumption, comprising:
an engine to provide tertiary content for playing on a content consumption device;
wherein the tertiary content is to be played while playing of secondary content of a media content is being fast-forwarded.

17. The apparatus of claim 16, wherein the apparatus comprises a content aggregation/distribution server, and the engine comprises a content provisioning engine; wherein the content provisioning engine to further provide the media and secondary content to the content consumption device.

18. The apparatus of claim 17, wherein the content provisioning engine to integrally provide the media content, the secondary content and the tertiary content in one content stream.

19. The apparatus of claim 17, wherein the content provisioning engine to separately provide at least the tertiary content.

20. The apparatus of claim 19, wherein the content provisioning engine to separately provide the tertiary content, in response to a request for the tertiary content.

21. The apparatus of claim 16, wherein the apparatus comprises an advertiser/agent server, and the engine comprises a commercial engine to provide the tertiary content to the content consumption device directly, or via a content aggregation/distribution server.

22. A method for providing content for consumption, comprising:
providing, by a content provisioning engine of a content aggregation/distribution server or a commercial engine of an advertiser/agent server, tertiary content for playing on a content consumption device;
wherein the tertiary content is to be played while playing of secondary content of a media content is being fast-forwarded.

23. The method of claim 22, wherein providing is performed by the content aggregation/distribution server, and the method further comprises providing, by the content provisioning engine, the media and secondary content to the content consumption device.

24. The method of claim 23, wherein providing the tertiary content is performed separately from providing the media and secondary content; and wherein providing the tertiary content comprises providing the tertiary content, in response to a request for the tertiary content.

25. The method of claim 22, wherein providing the tertiary content is performed by the advertiser/agent server, and providing the tertiary content comprises providing the tertiary content to the content consumption device directly, or via the content aggregation/distribution server.
